(19) United States
(12) Patent Application Publication
(10) Pub. No.: US 2026/0184322 A1
(43) Pub. Date: Jul. 2, 2026

(54) CONTROL UNIT FOR A CONTROL SYSTEM, CONTROL SYSTEM, AND MOTOR VEHICLE HAVING A CONTROL SYSTEM

(71) Applicant: HELLA GmbH & Co. KGaA, Lippstadt (DE)

(72) Inventors: Hüseyin DEMIR, Lippstadt (DE); Olaf HUSBERG, Warburg (DE); Christian ISEKE, Paderborn (DE); Sergey ORLOV, Paderborn (DE); Christoph WOSTMANN, Lippstadt (DE)

(73) Assignee: HELLA GmbH & Co. KGaA, Lippstadt (DE)

(21) Appl. No.: 19/547,904

(22) Filed: Feb. 24, 2026

Related U.S. Application Data
(63) Continuation of application No. PCT/EP2024/072864, filed on Aug. 14, 2024.

(30) Foreign Application Priority Data
Aug. 25, 2023 (DE) 10 2023 122 892.7

(51) Int. Cl. B60W 50/023; B60W 10/18; B60W 10/20; B60W 50/02; B62D 5/00; B62D 5/04

(52) U.S. Cl. CPC B60W 50/023; B60W 10/18; B60W 10/20; B60W 50/0205; B62D 5/003; B62D 5/046; B62D 5/0481; B60W 2510/202

(57) ABSTRACT

A control unit for a control system of a motor vehicle for controlling at least one function of the motor vehicle. The control unit comprises at least one computing unit for evaluating output signals provided to the control unit from at least one sensor of the control system, the sensor corresponding to the function, and for controlling power electronics of an actuator of the control system via control signals according to the output signals in order to perform the function of the motor vehicle. The control unit is in the form of only a single control unit of the control system, wherein the control unit has a total of three computing units and is designed and configured such that, only via the control unit, a main function and a secondary function of the motor vehicle can be controlled, irrespective of an error in only one of the three computing units.

This nonprovisional application is a continuation of International

Application No. PCT/EP 2024/072864, which was filed on Aug. 14, 2024, and which claims priority to German Patent Application No. 10 2023 122 892.7, which was filed in Germany on Aug. 25, 2023, and which are both herein incorporated by reference.

### BACKGROUND OF THE INVENTION

### Field of the Invention

The present invention relates to a control unit for a control system of a motor vehicle, a control system of a motor vehicle, and a motor vehicle having a control system.

### Description of the Background Art

Control units for control systems of motor vehicles, control systems for motor vehicles and motor vehicles are already known from the state of the art in numerous design variants.

This is where the present invention comes in.

### SUMMARY OF THE INVENTION

It is therefore an object of the present invention is to improve a control unit for a control system of a motor vehicle, a control system for a motor vehicle and a motor vehicle.

This object is achieved by a control unit, which is characterized in that the control unit is in the form of only a single control unit of the control system, wherein the control unit has a total of three computing units and is designed and configured such that, only via the control unit, can a main function and a secondary function of the motor vehicle can be controlled, irrespective of an error in only one of the three computing units. Further, this object is achieved by a control system for a motor vehicle according to claim 6 and a motor vehicle according to claim 10. The term “main function” here refers to functions of the motor vehicle that are elementary for the motor vehicle, wherein in particular safety-relevant functions of the motor vehicle, such as the steering, the drive or the braking system of the motor vehicle are to be understood. These main functions of the motor vehicle, for example the aforementioned main functions, must be carried out redundantly due to their safety relevance. This means that the redundantly executed main function can also be executed safely in the event of an error, for example a failure of a component of the control unit in the execution of this main function, since this erroneous component is automatically replaced by a corresponding redundant component in order to execute the main function in the event of an error. The term “secondary function” here refers to functions of the motor vehicle according to the invention which are in particular not safety-relevant and therefore do not have to be redundant. The subclaims relate to advantageous further developments of the invention.

A major advantage of the invention is in particular that a control unit for a control system of a motor vehicle, a control system for a motor vehicle and a motor vehicle are improved. Due to the design of the control unit, the control system and the motor vehicle according to the invention, sufficient redundancy for a so-called X-by-wire system or the like can be realized in a simple and thus cost-effective manner. Ensuring sufficient redundancy is particularly important for such systems and motor vehicles equipped with them because the mechanical couplings that exist in conventional motor vehicles and are relevant for the redundancy consideration are eliminated in such motor vehicles. For example, this is easily illustrated by the example of steering a motor vehicle with a steer-by-wire system, in which a so-called steer-by-wire system is used instead of the well-known mechanical connection between a steering wheel of the motor vehicle and the wheels of the motor vehicle to be steered. The aforementioned mechanical connection is eliminated. With regard to the example of the steering of a motor vehicle, the main function and the secondary function according to the invention can be designed as a secondary function developed as a steering wheel feedback function for mechanical action via a steering wheel of the motor vehicle on a driver of the motor vehicle and designed as a main function designed as a wheel steering function for steering at least one wheel of the motor vehicle according to a steering angle of the steering wheel adopted by the driver. However, the field of application of driving motor vehicles using steer-by-wire systems is only listed here purely by example. The invention can also be used advantageously in other main functions of motor vehicles. For example, only other by-wire systems, which are generally referred to as X-by-wire systems, should be mentioned here. The skilled person is well aware of the basic design of such X-by-wire systems. According to the invention, it is not necessary to provide a plurality of control units in order to realize, for example, the aforementioned functions, namely the main function and the secondary function, and the redundancy required for this. Instead, it is possible to use only a single control unit, i.e., a central control unit, to perform the two aforementioned functions of the motor vehicle. Accordingly, these two functions of the motor vehicle can only be implemented via only a single control unit instead of two control units, while maintaining the necessary redundancy. In the aforementioned exemplary design of the control system as a steering system with the steering wheel feedback function and the wheel steering function, the prior art would have required the components of the control system necessary for the respective function, such as the control unit, the at least one sensor, the power electronics and the actuator, on the one hand, namely with regard to the steering wheel feedback function, to be located on a steering column of the motor vehicle and, on the other hand, namely with regard to the wheel steering function, to be located on a steering axle of the motor vehicle. Since, for example, the aforementioned components of the steering wheel feedback function are also required for the wheel steering function, namely for sensing the steering angle of the steering wheel via the at least one sensor of the steering wheel feedback function, it would therefore also be necessary to install two instead of only one computing unit in the control unit of the steering wheel feedback function. Accordingly, a control system according to the state of the art would require a total of four computing units, namely two redundant computing units per control unit. In contrast, in the control system according to the invention for the steering system explained above, only a single control unit with a total of only three computing units is required. A computing unit is alternatively also referred to as a processing unit or a so-called controller, for example a microcontroller.

The control unit for a control system of a motor vehicle according to the invention, the control system for motor vehicles according to the invention and the motor vehicle according to the invention can be freely selected according to type, function, material and dimension within wide suitable limits. For example, reference is made here to motor vehicles designed as electric vehicles. See the multitude of different functions in modern motor vehicles, for example the above explanations of the challenges of X-by-wire systems in general.

A particularly advantageous further development of the control unit according to the invention provides that each of the three computing units is designed and configured such that automatic self-diagnosis for the detection of an error in this computing unit can be carried out in the respective computing unit and, depending on a detected error in this computing unit, a self-deactivation of this computing unit can be carried out automatically. This significantly improves the safety of the control system according to the invention with the control unit according to the invention and thus of the motor vehicle according to the invention. For example, within the respective computing unit of the control unit according to the invention, two computing cores are installed, which monitor each other for their proper functioning. If an error has been detected in the computing unit in the aforementioned manner, this computing unit then switches off automatically. Accordingly, depending on this, i.e., if an error in one of the computing units has been diagnosed in the aforementioned manner, it may be provided that this erroneous computing unit is excluded from the communication of the control unit during further operation.

As an alternative or in addition to the aforementioned further developments, another advantageous further developments of the control unit according to the invention provides that the control unit is designed and configured such that the output signals of the sensors in all computing units can be evaluated in parallel and, if only two of three corresponding control signals from the three computing units match, the computing unit that has the control signal deviating from the two other computing units can be automatically deactivated. In this way, a two-out-of-three decision is possible in normal operation of the control unit, i.e., in error-free operation of the three computing units of the control unit, wherein even in the event of an error in only one of the three computing units of the control unit, safe operation of the aforementioned main function and the aforementioned secondary function of the motor vehicle is possible. Accordingly, the safety in the operation of the motor vehicle according to the invention is significantly improved.

A further advantageous further development of the control unit according to the invention provides that the three computing units of the control unit are designed and configured such that calculations for at least one other function of the motor vehicle can be carried out via the computing units, in addition to the aforementioned main function and the aforementioned secondary function of the motor vehicle in normal operation of the control unit, i.e., if all three computing units are functioning properly. This makes it possible, for example, in the normal operation of the control unit according to the invention, i.e., if all three computing units function without errors, to use free computing capacity of the three computing units for calculations corresponding to a further function of the motor vehicle according to the invention. For example, these calculations may be calculations for another secondary function of the motor vehicle, for example an air conditioning function for the air conditioning of the vehicle interior of the motor vehicle. As already explained above, the term “secondary function” here refers to functions of the motor vehicle according to the invention which are in particular not relevant to safety and thus do not require redundancy. Of course, the aforementioned free computing capacity can also be used to realize redundancy in the additional functions. In the event of an error, i.e., if one of the three computing units of the control unit according to the invention is no longer functioning properly, this additional functionality of the control unit according to the invention can then be set automatically, for example, so that only the aforementioned main function and the aforementioned secondary function are carried out via the control unit according to the invention.

Another advantageous further development of the control unit according to the invention provides that the control unit is in the form of a single component, preferably that all computing units of the control unit are designed to be essentially identical to each other only functionally. In this way, the control unit according to the invention is very compact and thus easier to handle. The preferred example of this development also has the further advantage that the computing units can be procured, for example, from different manufacturers. This results in additional diversification in the computing units, which can be used to improve the functional reliability of the control unit. This is because although the computing units are essentially functionally identical, their structure can vary from manufacturer to manufacturer. Accordingly, a failure of two computing units from different manufacturers due to the same error is practically very unlikely.

As already explained above, the control system according to the invention can be freely selected within wide suitable limits.

An advantageous further development of the control system according to the invention provides that the control system is designed and configured such that the entire logic of the control system is integrated into the control unit. This means that all the logic, i.e., everything that has to do with calculation and communication on the one hand within the control system according to the invention and on the other hand between the control system according to the invention and the rest of the motor vehicle according to the invention that is different from the control system according to the invention, is concentrated on the control unit according to the invention. The remaining components of the control system according to the invention for the realization of the main function and the secondary function thus have only at least one actuator and only at least one sensor for each of the aforementioned functions. Signal precomputing or the like therefore also does not take place in these components outside the control unit according to the invention. Thus, via the only one control unit, a centralized logic unit is created, which provides the control of the actuator corresponding to the main function and the secondary function in the normal operation of the control unit according to the invention as well as in the event of error, i.e., in the event of failure of only one of the three computing units.

Another advantageous further development of the control system according to the invention provides that the control system is designed as a steer-by-wire system of the motor vehicle, preferably that the steer-by-wire system is designed as a steering system of the motor vehicle, wherein the controlled secondary function is designed as a steering wheel feedback function for mechanical action via a steering wheel of the motor vehicle on a driver of the motor vehicle and the controlled main function is in the form of a wheel steering function for steering at least one wheel of the motor vehicle according to the steering angle of the steering wheel adopted by the driver. As already explained in the introductory description, the control system according to the invention is particularly advantageous in steering systems of motor vehicles, in which, for example, there is no longer any mechanical connection between the steering wheel on one side and at least one wheel on the other side, since the invention ensures sufficient redundancy despite a smaller number of computing units. This is especially true for the example of this further development.

Another advantageous further development of the control system according to the invention provides that the at least one other function is developed as a further main function of the motor vehicle, preferably that the further main function is developed as a drive function of the motor vehicle or as a brake function of the motor vehicle. The terms “drive function” and “brake function” are to be interpreted broadly and also include, for example, a driving stability function and a recuperation function of the motor vehicle. In this way, a free computing capacity of the three computing units of the control unit according to the invention can be used in normal operation of the control unit, for example, to realize additional redundancy in the other main function, so that the additional components required for this purpose can be dispensed with in the control system according to the present further development. This is particularly advantageous in the other main functions according to the example of this further development since these other main functions are highly sensitive and thus particularly safety-relevant main functions of the motor vehicle according to the invention. Of course, the additional function can also be designed as any other function of the motor vehicle, for example as a further secondary function of the motor vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of the control system for a motor vehicle according to the invention having the control unit according to the invention in a process circuit diagram.

FIG. 1 shows an example of the control system for a motor vehicle according to the invention having the control unit according to the invention purely by way of example.

### DETAILED DESCRIPTION

In the present example, the control system 2 of an unspecified motor vehicle 1, namely an electric vehicle, is designed as a steer-by-wire system of the motor vehicle 1, wherein the steer-by-wire system is in the form of a steering system of motor vehicle 1.

Via the control system 2, a main function and a secondary function of the motor vehicle 1 are controlled, wherein the control system 2 has only a single control unit 4, and wherein the control unit 4 comprises a total of three computing units 6, 8, 10 for evaluating output signals from at least one sensor, the sensor corresponding to the respective aforementioned function 12, 14 of the control system 2, and for controlling power electronics 16, 18 of an actuator 20, 22 of the control system 2 corresponding to one of the aforementioned functions via control signals according to the aforementioned output signals for the execution of the main function and the secondary function of the motor vehicle 1. The three computing units 6, 8, 10 are each supplied with a redundant electrical voltage. Furthermore, the computing units 6, 8, 10 each communicate via duplicate communication channels with the rest of the control system 2 as well as with the rest of the motor vehicle 1 that is distinct from the control system 2. Accordingly, the control unit 4 is designed as only a single control unit 4 of the control system 2.

The two functions controlled by the control system 2 in the present example are, firstly, a secondary function in the form of a steering wheel feedback function for the mechanical action via a steering wheel 24 of the motor vehicle 1 on a driver of the motor vehicle 1, and secondly, a main function designed as a wheel steering function for steering at least one wheel of the motor vehicle 1, according to a steering angle of the steering wheel 24 adopted by the driver. Using the steering wheel feedback function, sensor information is collected on the steering wheel 24 via the sensor 14 in order to generate feedback torque for the driver via the actuator 22 on the one hand and to make the driver's steering wishes available to the wheel steering function on the other. On the one hand, the wheel steering function steers the vehicle wheels of the motor vehicle 1 that are not displayed, and on the other hand, road conditions are transmitted to the steering wheel feedback function via the wheel steering function. Thus, in the aforementioned manner, there is a constant exchange of signals and/or data between the two aforementioned functions of the motor vehicle 1.

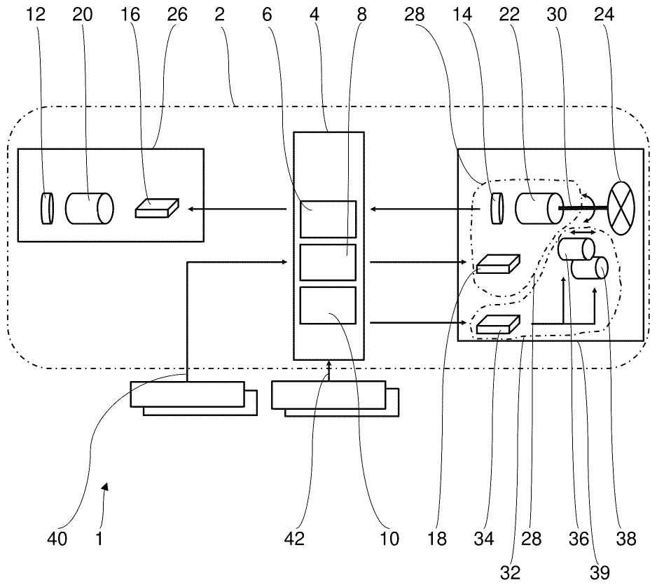

The actuators 20, 22 shown in FIG. 1 are each an electric motor; the sensors 12, 14 are each so-called motor position sensors. These motor position sensors 12, 14 can be formed multiple times, i.e., redundantly. In particular, the individual sensors of these motor position sensors 12, 14 can each be based on different physical measurement principles, so that this results in an improvement in reliability on the one hand through this technological diversity of the sensors 12, 14 and on the other hand through the aforementioned redundancy.

In order to implement the two aforementioned functions of the control system 2, the control unit 4 in the present example is designed and configured such that automatic self-diagnosis can be carried out in the respective computing unit 6, 8, 10 to detect an error in this computing unit 6, 8, 10 and, according to the detected error in this computing unit 6; 8; 10, a self-deactivation of this computing unit 6; 8; 10 can be executed automatically. See also the examples in this regard in the introductory description.

In addition, in the present example, each of the three computing units 6, 8, 10 is designed and configured such that the output signals of the sensors 12, 14 can be evaluated in parallel in all computing units 6, 8, 10 and, if only two of the three corresponding control signals of the three computing units 6, 8, 10 match, the computing unit 6; 8; 10 that has the two remaining computing units 8, 10; 6, 10; 6, 8 can be automatically deactivated. In normal operation of the control unit 4, i.e., if there is no error in one of the computing units 6, 8, 10, all three computing units 6, 8, 10 each provide essentially the same control signal for controlling the power electronics 16, 18 of the actuators 20, 22 based on the output signals of the sensors 12, 14 provided to the control unit 4. Should any of the computing units 6, 8, 10 not be functioning properly, this is automatically detected, independently of the aforementioned automatic self-diagnosis, via the two-out-of-three decision in accordance with this paragraph and, according to this, the erroneous computing unit 6; 8; 10 automatically shuts off. Despite this error-based shutdown of one of the three computing units 6, 8, 10, the main function and the secondary function are carried out properly via the control unit 4. This also includes a limited performance of the respective function, which will be explained in more detail below.

Thus, in the present example, the control unit 4 is designed and configured such that the aforementioned main function and the aforementioned secondary function of the motor vehicle 1 can be controlled solely via this control unit 4, irrespective of an error in only one of the three computing units 6, 8, 10.

Furthermore, the three computing units 6, 8, 10 of the control unit 4 are designed and configured such that calculations for at least one other function of the motor vehicle 1 can be carried out via the computing units 6, 8, 10, in addition to the aforementioned main function and the aforementioned secondary function of the motor vehicle 1, in normal operation of the control unit 4, i.e., if all three computing units 6, 8, 10 are functioning properly. The at least one other function is designed here as a further secondary function of the motor vehicle 1, namely as a steering wheel adjustment function of the motor vehicle 1. However, it is also conceivable that in other example of the invention the further function is designed as another secondary function, for example an air conditioning function for a passenger compartment of a motor vehicle or the like, or as a further main function of the motor vehicle, wherein the further main function may be developed, for example, as a drive function of the motor vehicle or as a brake function of the motor vehicle. See also the corresponding examples in the introductory description.

In the present example, the control unit 4 is designed as a single assembly, wherein all three computing units 6, 8, 10 of the control unit 4 are essentially identical to each other only functionally. See the examples in this regard in the introductory description. In addition, the control unit 4, which is designed as a single assembly, is arranged in a low-stress area of the motor vehicle 1 via a non-shown supporting structure of the motor vehicle 1 in such a way that the control unit 4 is essentially protected from mechanical and thermal stresses on the motor vehicle 1 and from the environment of the motor vehicle 1. The control unit 4, which is designed as a central control unit for the main function and the secondary function of the steering system 2, is therefore not disposed in the area of the wheels of the motor vehicle 1, namely not on a non-specified steering axle of the motor vehicle 1, in contrast to a subgroup 26 of the control system 2 made up of sensor 12, power electronics 16 and actuator 20, which is designed as an assembly. A further subgroup 28 of the control system 2 made up of sensor 14, power electronics 18 and actuator 22 is located on a steering column 30 of the motor vehicle 1 that is torque-connected to the steering wheel 24. In the present example, a further subgroup 32 of the control system 2 is arranged at the steering column 30 for the implementation of the aforementioned steering wheel adjustment function, i.e., for the adjustment of the steering wheel 24, wherein this subgroup 32 has power electronics 34 that can be controlled by the control unit 4 and two corresponding actuators 36, 38. The two actuators 36, 38 are also each designed as an electric motor. The steering wheel adjustment function allows for the steering wheel 24 to be tilted and the steering wheel 24 to be stowed away. Subgroups 28 and 32 can be combined into a common assembly 39. In the present example, the control system 2 is designed and configured such that the entire logic of the control system 2 is integrated into the control unit 4. This also applies to the communication of the control system 2 with the rest of the motor vehicle 1 that is distinct from the control system 2. This communication is symbolized in FIG. 1 by an arrow 40. The same applies to a power supply to the control system 2, which is also centrally supplied via the control unit 4. This power supply is symbolized in FIG. 1 by an arrow 42. Accordingly, the aforementioned subgroups 26, 28, 32 of the control system 2 do not have any logic of their own. See the corresponding explanations in the introductory description.

In the following, the functioning of the control system for a motor vehicle according to the invention having the inventive control unit according to the present example is explained in more detail on the basis of FIG. 1.

If, for example, the steering wheel 24 of the motor vehicle 1 is manually rotated around the steering column 30, this steering movement of the steering wheel 24 is detected via the sensor 14 functionally connected to the steering wheel 24 in a manner known in itself, and is forwarded as output signals of this at least one sensor 14 in a manner known in itself, for example via an unspecified bus system of the control system 2, to the control unit 4 of the control system 2. These output signals are fed to all three computing units 6, 8, 10 for evaluation, i.e., for calculation. In order to be able to properly control the power electronics 16 of the actuator 20, it is also necessary that the current steering position of the at least one steerable wheel of the motor vehicle 1 is known. This current steering position is detected via at least one sensor 12, which is functionally interacting with the actuator 20, also known to the skilled person, and is forwarded in the form of output signals from the sensor 12, analogous to the aforementioned output signals, in parallel to the three computing units 6, 8, 10 for evaluation. After the parallel evaluation of all output signals in all three computing units 6, 8, 10, each of the three computing units 6, 8, 10 generates a control signal correlating to these output signals, which can be used to control the power electronics 16 of the actuator 20. If all three computing units 6, 8, 10 are functioning properly, i.e., in normal operation of the control unit 4, the aforementioned control signals are essentially the same.

If all three computing units 6, 8, 10 are functioning properly, the power electronics 16 of the actuator 20 are controlled by the control unit 4 such that actuator 20 is energized via the power current connection 42.

If one of the computing units 6, 8, 10 is not functioning properly, this is automatically determined in one of the ways explained above, wherein even in the event of an error in only one of the three computing units 6, 8, 10 of the control unit 4, safe operation of the main and secondary functions of the motor vehicle 1 controlled by the control system 2 is made possible. Thus, the operation of the actuator 20 described above, and therefore the wheel steering function of the control system 2 can be properly maintained even in the event of an erroneous computing unit 6; 8; 10 of the control unit 4. According to the invention, the maintenance of the respective function is also to be understood as the operation of the respective function of the motor vehicle 1 with limited, i.e., reduced, power or the like. In the aforementioned error case, it is important that the control system 2, and thus the motor vehicle 1, is operated in a safe state so that the driver of the motor vehicle 1, any other occupants of the motor vehicle 1 and any other road users are not endangered. For example, in the aforementioned error, an automatic speed limit can be set when driving the motor vehicle 1, so that the motor vehicle 1 can be transported to a repair shop independently but safely.

The same applies to the steering wheel feedback function of the control system 2 via subgroup 28 of the control system 2. In contrast, the steering wheel adjustment function of the control system 2 with subgroup 32, which is developed as a further secondary function, can be discarded, i.e., automatically switched off, in the event of an error of one of the computing units 6; 8; 10. Accordingly, the computing capacity still available in the aforementioned error case is available exclusively for the execution of the main function and the secondary function of the control system 2.

Due to the design of the control unit 4, the control system 2 and the motor vehicle 1 according to the invention, sufficient redundancy for the control system 2, which is designed as a steer-by-wire system, can be realized in a simple and thus cost-effective manner. The secondary function and main function controlled by the control system 2 may, with regard to the example of the steering of the motor vehicle 1, be designed as the steering wheel feedback function for the mechanical action via the steering wheel 24 on the driver of the motor vehicle 1 and be designed as the wheel steering function for steering at least one wheel of the motor vehicle 1 according to the steering angle of the steering wheel 24 adopted by the driver. However, the field of application of driving motor vehicles using steer-by-wire systems is only listed here purely by example. The invention can also be advantageously applied to other main and secondary functions of motor vehicles. For example, only other by-wire systems, which are generally referred to as X-by-wire systems, should be mentioned here. According to the invention, it is therefore not necessary to provide a plurality of control units in order to realize, for example, the aforementioned main function and the aforementioned secondary function and the redundancy required for this according to the example. Instead, only one control unit 4 is sufficient to perform this main function and this secondary function of the motor vehicle 1. Accordingly, this main function and this secondary function of the motor vehicle 1 can be realized via only the single control unit 4 instead of two control units, while maintaining the necessary redundancy, so that instead of a total of four computing units, namely two redundant computing units per control unit in accordance with the prior art, only the three computing units 6, 8, 10 of the control unit 4 are required.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control unit for a control system of a motor vehicle for controlling at least one function of the motor vehicle, the control unit comprising:
at least one computing unit to evaluate output signals provided to the control unit from at least one sensor of the control system, the sensor corresponding to the function, and for controlling power electronics of an actuator of the control system via control signals according to the output signals in order to perform the function of the motor vehicle,
wherein the control unit is a single control unit of the control system, and
wherein the control unit has a total of three computing units and is designed and configured such that, only via this control unit, a main function and a secondary function of the motor vehicle is controlled, irrespective of an error in only one of the three computing units.

2. The control unit according to claim 1, wherein each of the three computing units is designed and configured such that an automatic self-diagnosis for the detection of an error in this computing unit is carried out in the respective computing unit and, according to a detected error in this computing unit, a self-deactivation of this computing unit is carried out automatically.

3. The control unit according to claim 1, wherein the control unit is designed and configured such that the output signals of the sensors are evaluated in parallel in all computing units and, if only two of three corresponding control signals of the three computing units match, the computing unit is automatically deactivated with the control signal deviating from the other two computing units.

4. The control unit according to claim 1, wherein the three computing units of the control unit are designed and configured such that calculations for at least one other function of the motor vehicle are carried out via the computing units, in addition to the main function and the secondary function of the motor vehicle, in normal operation of the control unit in which all three computing units function properly.

5. The control unit according to claim 1, wherein the control unit is designed as a single assembly, or wherein all computing units of the control unit are designed to be essentially identical to each other only functionally.

6. A control system of a motor vehicle for controlling at least one function of the motor vehicle, the control system comprising:
at least one control unit that comprises at least one computing unit to evaluate output signals provided to the control unit from at least one sensor of the control system, the sensor corresponding to the function, and for controlling power electronics of an actuator of the control system via control signals according to the output signals in order to perform the function of the motor vehicle, the actuator corresponding to the function,
wherein the control unit is in the form of only a single control unit of the control system according to claim 1.

7. The control system according to claim 6, wherein the control system is designed and configured such that the entire logic of the control system is integrated into the control unit.

8. The control system according to claim 6, wherein the control system is designed as a steer-by-wire system of the motor vehicle, or the steer-by-wire system is designed as a steering system of the motor vehicle, wherein the controlled secondary function is designed as a steering wheel feedback function for mechanical action via a steering wheel of the motor vehicle on a driver of the motor vehicle and the controlled main function is designed as a steering wheel function for steering at least one wheel of the motor vehicle according to a steering angle of the steering wheel adopted by the driver.

9. The control system according to claim 6, wherein at least one other function is developed as a further main function of the motor vehicle, or wherein the other main function is designed as a driving function of the motor vehicle or as a braking function of the motor vehicle.

10. A motor vehicle comprising a control system according to claim 6, wherein the control unit is designed as a single assembly and is arranged in a low-stress area of the motor vehicle via a supporting structure of the motor vehicle such that the control unit is essentially protected from mechanical and/or thermal stresses on the motor vehicle and from the environment of the motor vehicle.
